(19) United States
(12) Patent Application Publication
(10) Pub. No.: US 2026/0118073 A1
(43) Pub. Date: Apr. 30, 2026

(54) TUBE-SHEET ASSEMBLY FOR UREA PLANT

(71) Applicant: Stamicarbon B.V., Sittard (NL)

(72) Inventors: Alexander Aleida Antonius SCHEERDER, Roosteren (NL); Markus Theodorus Marie Michaël WAGEMANS, Roermond (NL)

(73) Assignee: Stamicarbon B.V., Sittard (NL)

(21) Appl. No.: 19/470,601

(22) PCT Filed: Jul. 8, 2025
(86) PCT No.: PCT/NL2025/050334

§ 371 Date: Sep. 29, 2025

(30) Foreign Application Priority Data
Jul. 9, 2024 (EP) 24187533.5

(51) Int. Cl. F28F 9/013; B01D 5/00; B01J 3/04; B01J 19/00; C22C 38/00; C22C 38/02; C22C 38/04; C22C 38/42; C22C 38/44; C22C 38/58; F28F 21/08

(52) U.S. Cl. CPC F28F 9/0131; B01D 5/0009; B01J 3/042; B01J 19/0013; C22C 38/001; C22C 38/002; C22C 38/02; C22C 38/04; C22C 38/42; C22C 38/44; C22C 38/58; F28F 21/082; B01J 2219/00092; B01J 2219/00103

(57) ABSTRACT

Disclosed is a tube-sheet suitable for holding a tube bundle of a shell-and tube heat exchanger adapted to withstand the pressure at the shell side. Said sheet comprises a carbon steel plate provided with a plurality of holes. Both surfaces of the tube-sheet are covered by a weld overlay, said weld overlay comprising a layer of duplex stainless steel on at least one surface thereof. The sleeves are fixed to the tube-sheet by means of a weld connection to either weld overlay. Hereby at least one such connection is on the inside of the holes.

### FIELD OF THE INVENTION

The invention is in the field of urea production, and relates to heat exchange in a corrosive carbamate environment. Particularly, the invention pertains to a tube-sheet assembly for use in such environment.

### BACKGROUND OF THE INVENTION

Urea is generally produced from ammonia and carbon dioxide. It can be prepared by introducing an ammonia excess together with carbon dioxide at a pressure between 12 and 40 MPa and at a temperature between 150° C. and 250° C. into a urea high pressure synthesis section. Typical urea production plants further comprise a recovery section operating at medium pressure and/or low pressure, and a finishing section.

The high pressure synthesis section generally comprises a reactor, a stripper, and a high-pressure carbamate condenser, which are in fluid communication with each other in such a way as to provide a urea synthesis loop. In the medium and low pressure recovery sections, unreacted ammonium carbamate, as well as ammonia and carbon dioxide originating from decomposed ammonium carbamate as well as unreacted reactants, are recovered and recirculated, generally in the form of ammonium carbamate, to the high pressure synthesis section.

An interesting development in the production of urea is that of plants designed with the aim to reduce energy. A key feature in such ultra-low energy (ULE) urea plant, is a high-pressure vessel equipped with two U-bundles, i.e., U-shaped tubes generally used for heat exchange of medium flowing through the tubes and medium outside the tubes (either at a shell side thereof or the surrounding space in the vessel).

The foregoing vessel combines the functions of the high-pressure reactor and the high-pressure carbamate condenser. As such, a combined apparatus of this type has been known, usually indicated as a “pool reactor” or a “pool condenser.” The added feature in the low energy concept, is that of having a second U-bundle. A first bundle serves to remove heat from the carbamate reaction at the shell side (high pressure synthesis). Generally, the heat-exchange medium thereby used, flowing through the tube, is steam condensate originating from a low-pressure recovery section. The second bundle removes the reaction heat from the carbamate reaction at the shell side (high pressure synthesis) by feeding and partly evaporating a urea/carbamate solution from a medium-pressure section.

A tube bundle, which generally comprises a plurality of individual relatively narrow tubes, will normally be connected, and held together, via a tube-sheet. Such tube-sheet necessarily comprises a plurality of holes corresponding to the number of tubes connected to it. Other than in the event of circulating steam through such tubes, the added tubes in which a medium pressure ammonium carbamate solution is circulated, present a problem related to the inevitable corrosiveness of such medium pressure carbamate. Specifically, the carbamate will cause corrosive action on the holes of the tube-sheet. More particularly, as a result of the constant flow of the carbamate, the action is not merely corrosive, but notably causes also erosion. It will be understood that such corrosion and erosion result in enlargement of the holes, which can weaken the tube-sheet in such way that the integrity of the vessel cannot be guaranteed anymore and creates hazardous situation, associated with safety concerns.

It is therefore desired to prepare a tube-sheet that is protected against the aforementioned corrosion and/or erosion. This, however, is not a readily available attribute of a tube-sheet in the condensation apparatus of the low energy urea production process. Particularly, the tube-sheet needs to withstand a high pressure, namely the pressure on the shell side (inside). This necessitates a tube-sheet of a substantial thickness, namely typically of the order of 300 to 500 mm. It is not normally possible to manufacture such a tube-sheet out of a single sheet of corrosion resistant material such as the Safurex® brand of duplex stainless steel, that is also used in other equipment parts of urea plants that are prone to contact with hot ammonium carbamate.

It is not possible to produce a sheet of the abovementioned thickness via normal production methods and have an isotropic microstructure throughout the sheet. It is well known that the microstructure determines the corrosion resistance of the material. This is particularly the case when holes are drilled through the tube-sheet to allow connection with the tubes. This would produce a cross-cut surface which would be susceptible to cross-cut end attack. With normal production methods thus being unsuitable, manufacturing a relatively thick tube-sheet from duplex stainless steel would be a very costly and difficult to manufacture solution. For this reason, a tube-sheet is typically manufactured out of carbon steel to withstand the pressure, but carbon steel is not corrosion resistant. Moreover, on the basis of forging experiments, the inventors found that also in the event of duplex stainless steel, a thickness of 300 mm to 500 mm presents a difficulty in guaranteeing the desired corrosion resistance over the full thickness of the tube-sheet.

A problem with the risk of corrosion still possibly occurring, is that it will not normally be discovered until it causes visible damage. In the intended application. i.e., in a high-pressure urea synthesis section, such damage may result in a breach of the high-pressure equipment, which present a direct hazard to plant operators as well as to the environment.

Accordingly, it is desired to find a solution by which in a more economical way a tube-sheet can be provided that is sufficiently protected to the circumstances of carrying a tube bundle in a corrosive carbamate environment. Preferably, it would also be desired if such tube-sheet could be provided with a system allowing early detection of corrosion, in order to be able to shut down and repair the equipment before a hazardous situation occurs.

By way of background art, we refer to WO2013/165247. Herein a method is disclosed for manufacturing a tube-sheet and heat exchanger assembly for a pool reactor or a pool condenser. The method comprises providing inserting sleeves of an austenitic-ferritic duplex stainless steel grade through the tube-sheet. This is done such that both ends of the sleeve extend in a direction away from the tube-sheet, upon which the ends of a bundle of U-shaped tubes are connected to the ends of the sleeves. This is a complicated manufacturing process, since it requires a high precision, particularly with respect to the lengths of the tubes of a tube bundle, and the corresponding lengths of the extending parts of the sleeves, to connect the tubes and the sleeve ends to each other. Even minute differences in length present a difficulty in providing sufficiently strong and protective welds between the sleeves and the tubes. Additionally, connecting sleeve ends and tubes whilst attempting to accommodate differences in length, will introduce stress, adversely affecting the strength of the welds. It is thus desired to provide a method and configuration allowing tubes of a tube bundle and corrosion-protective sleeves for a tube-sheet, to be connected in a more convenient and more secure manner. Another issue concerns the desirability to provide the tube-sheet with a leak detection system. Preferably, such system should be able to detect leaks possibly occurring in the most vulnerable sports, particularly at weld connections. In WO2013/165247 such system is described, but this does not optimally cover all weld connections. Particularly, the leak detection system does not extend to the connection of the tubes and the sleeves. It is desired to improve this.

### SUMMARY OF THE INVENTION

In order to better address one or more of the foregoing desires, the invention provides, in one aspect, a tube-sheet assembly suitable for holding a tube bundle of a shell-and tube heat exchanger, said tube-sheet assembly comprising a carbon steel sheet having first and second sheet surfaces facing away from each other, said carbon steel sheet being covered on either sheet surface by a weld overlay comprising an outer layer made of duplex stainless steel, said tube-sheet assembly being provided with a plurality of holes defined by hole walls extending from one outer surface to the other, wherein said holes are provided on the inside with a sleeve made of duplex stainless steel, the sleeves protecting the carbon steel part of the hole walls in their entirety, wherein the sleeves are fixed to the tube-sheet assembly by means of a weld connection to either weld overlay, and wherein on at least one end of the sleeves said weld connection is on the inside of the hole.

In another aspect, the invention presents a tube bundle heat-exchanger comprising at least one U-shaped tube bundle, said tubes comprising first and second leg portions connected by a bend portion, either leg having first and seconds tube ends facing away from the bend portion, said tube ends being configured for fluid connection allowing fluid to enter the tubes at a first tube end and exit the tubes at a second tube end, wherein said first and second tube ends are connected with a tube-sheet assembly, said tube-sheet assembly comprising a carbon steel sheet covered on either sheet surface by a weld overlay comprising an outer layer made of duplex stainless steel, said tube-sheet assembly being provided with a plurality of holes defined by hole walls extending from one outer surface to the other, wherein said holes are provided on the inside with a sleeve made of duplex stainless steel, the sleeves protecting the carbon steel part of the hole walls in their entirety, wherein the sleeves are fixed to the tube-sheet assembly by means of a weld connection to either weld overlay, and wherein at the side of tube-sheet assembly having the connection with the tube ends, the weld connection of the sleeves is on the inside of the holes.

In yet another aspect, the invention presents a condensation apparatus comprising a pressure vessel, said pressure-vessel provided with a shell-and tube heat exchanger as described in the preceding paragraph, wherein, at the surface of the tube-sheet assembly facing away from the tube bundle, the holes in the tube-sheet assembly are in fluid communication with one or more outlets of the pressure vessel.

In a further aspect, the invention resides in a urea production unit comprising a high-pressure synthesis section comprising a HP stripper, a reaction zone, and a high pressure carbamate condensation apparatus as described in the preceding paragraph, wherein the high pressure synthesis section has a liquid flow connection for urea solution through an expansion device configured to be operated at medium pressure or low pressure, to an inlet of the at least one U-shaped tube bundle of said condensation apparatus.

In a still further aspect, the invention is a method of modifying a pre-existing urea production unit, said unit comprising a tube bundle heat exchanger comprising at least one U-shaped tube bundle, said tubes comprising first and second leg portions connected by a bend portion, either leg having first and seconds tube ends facing away from the bend portion, said tube ends being configured for fluid connection allowing fluid to enter the tubes at a first tube end and exit the tubes at a second tube end, wherein said first and second tube ends are connected with a tube-sheet, said tube-sheet comprising a carbon steel plate having first and second sheet surfaces facing away from each other, said plate being provided with a plurality of holes defined by carbon steel hole walls extending from the first sheet surface to the second sheet surface, said holes having a fluid connection with the tube ends connected thereto, wherein the method comprises replacing the tube bundle heat exchanger by a tube bundle heat exchanger as described above in the corresponding aspect of the invention.

The invention also pertains to a process for the production of urea from ammonia and carbon dioxide carried out in a urea production plant according to the invention, the process comprising supplying gas from the HP stripper to the shell side of the HP carbamate condensation apparatus and condensing said gas into carbamate at least in part at said shell side and converting said carbamate at least in part into urea at said shell side, and supplying an MP urea solution also comprising carbamate to said inlet for an MP urea-comprising stream.

### BRIEF DESCRIPTION OF THE DRAWINGS

FIG. 1 schematically illustrates a tube-sheet assembly according to the invention. FIG. 2, FIG. 3, and FIG. 4 depict details of the tube-sheet assembly of FIG. 1. FIG. 5 schematically illustrates an HP condensation apparatus (according to WO 2023/219506) in which a tube-sheet assembly of the invention can be applied. The figures do not limit the invention or the claims.

### DETAILED DESCRIPTION OF THE INVENTION

The tube-sheet assembly disclosed herein will have a first sheet surface intended to be positioned at the side of high-pressure urea synthesis environment. It will have a second sheet surface, facing away from said first sheet surface, intended to be positioned at the side facing away from the high-pressure urea synthesis environment. In traditional pool reactors or submerged condensers, the second sheet surface will be subjected solely to contact with steam. In the context of an ULE type urea plant, this side will also comprise the inlets into the corresponding tubes for medium-pressure ammonium carbamate solution.

The tube-sheet assembly of the invention is suitable for holding a tube bundle of a shell-and tube heat exchanger. As the skilled person will be aware, such a shell-and-tube heat exchanger typically is intended for use in a pressure vessel, and the thickness of the tube-sheet assembly must be selected such to withstand the internal pressure.

A tube-sheet generally can be a single plate, or an assembly comprising a plurality of layers. In the disclosed tube-sheet assembly, overlay welded layers are added to a carbon steel tube-sheet.

The term “sheet surface” as used herein, indicates the generally flat top and bottom surfaces of a sheet, i.e., a plate-shaped material, rather than the edges of such sheet or plate. These surfaces, in a tube-sheet, including a tube-sheet assembly as disclosed herein, are generally perpendicular to the tubes positioned into such tube-sheet.

The invention is based on the judicious insight how to adapt such tube-sheet in order to better facilitate the connection of sleeves serving to protect the holes of the tube-sheet against corrosion. Further, the tube-sheet assembly of the invention better addresses the desire to enable the early detection of corrosion. In fact, the invention provides a synergistically combined benefit. One is that, other than in WO2013/165247, the connections of both the sleeves and the tubes can essentially be covered by a leak detection system. The other is that, also in deviation from the disclosure in WO2013/165247, leak detection grooves can be positioned as desired along the length of the sleeves. This enables judiciously positioning them at or near the middle of the length of the sleeves, thus optimally serving to detect leaks from either end of the sleeves.

To this end, in marked deviation from WO2013/165247, the sleeves are fixed to the tube-sheet assembly by means of a weld connection on both sides to a weld overlay. Particularly, thereby, on at least one end of the sleeves said weld connection is on the inside of the hole. This generally is accomplished by means of an internal bore welding technique. At the other end (generally, in the event that tube bundles are connected to the tube-sheet assembly, at the side facing away from the tubes), it is possible to also have an internal bore weld. Preferably, at said other end, the sleeves extend beyond the holes, and have a weld connection to the overlay weld at the outside surface of the tube-sheet assembly, preferably in the form of a fillet weld.

Said sleeves are made of corrosion resistant stainless steel. The person skilled in the art is familiar with such steel types. This is, e.g., austenitic stainless steel, such as, e.g., AISI316L or INOX 25-22-2 Cr/Ni/Mo steel. Preferably, however, corrosion resistant stainless steel is selected having a thermal expansion relatively close to that of carbon steel. Preferred corrosion resistant stainless steel is duplex stainless steel, such as 2205 or 2507 type duplex steels. Suitable steel is hereby in short indicated as duplex stainless steel, and preferably is of a so-called super duplex stainless steel. Duplex stainless steel refers to ferritic-austenitic alloy. Such alloys have a microstructure comprising ferritic and austenitic phases. Background references in this respect include WO 95/00674 and U.S. Pat. No. 7,347,903. Preferably, the sleeves are made of super duplex stainless steels such as Safurex® (Stamicarbon), DP28W™ (Toyo), Uremium29 and DMV29.7.

Duplex steels are particularly preferred in view of optimizing the connection of the sleeves to the tube-sheet assembly. During heating up/cooling down, these duplex steels are less prone to result in stresses due to differences in thermal expansion, and thus better protected against loosening of the sleeves over time or cracking of the weld connecting the sleeve to the tube-sheet which will lead to leaking carbamate to the carbon-steel tube-sheet. Preferred steel types are Safurex® grades, since Safurex® is much stronger compared to other duplex stainless steels, and still less prone to getting loose during thermal cycles. Duplex steels come in different alloying contents. Standard duplex stainless steel (2205-type) typically has a chromium content of about 21-23% and a nickel content below 5 wt. %, such as 22 wt. % Cr and 5% Ni. Higher alloyed (2507-types, i.e. 25 wt. % Cr or higher, and 7 wt. % Ni), are called super duplex stainless steels.

Standard duplex stainless steel is commonly referred to as a 2205 type steel. The 2205-type has an elementary composition typically consisting of: C<0.03; Cr 21.0-23.0; Ni 4.50-6.50; Mo 2.50-3.50; N −0.12-0.20, the balance being Fe and unavoidable impurities. The 2507-type has an elementary composition typically consisting of: C<0.03; Cr 24.0-27.0; Ni 4.50-7.50, Mo 2.00-4.50; N 0.12-0.28; W<0.50, the balance being Fe and unavoidable impurities.

Typically preferred super duplex stainless steel is a ferritic-austenitic steel alloy, the elementary composition of which consists of, in percentages by weight:

| | |
|---|---|
| C | 0-0.05; |
| Si | 0-0.8; |
| Mn | 0-4.0; |
| Cr | 26-35; |
| Ni | 3.0-10; |
| Mo | 0-4.0; |
| N | 0.30-0.55; |
| Cu | 0-1.0; |
| W | 0-3.0; |
| S | 0-0.03; |
| Ce | 0-0.2; |

the balance being Fe and unavoidable impurities.

Another preferred super duplex stainless steel has an elementary composition consisting of, in weight % (wt. %):

| C | max | 0.030; |
|---|---|---|
| Si | max | 0.8; |
| Mn | max | 2.0; |
| Cr | 29.0 | to 31.0; |
| Ni | 5.0 | to 9.0; |
| Mo | less than 4.0; | |
| W | less than 4.0; | |
| N | 0.25-0.45; | |
| Cu | max | 2.0; |
| S | max | 0.02; |
| P | max | 0.03; |

with the balance being Fe and unavoidable occurring impurities; and wherein the content of Mo+W is greater than 3.0 but less than 4.0.

The presence of the sleeves enables the holes to be protected against corrosion and erosion due to an ammonium carbamate stream flowing through the tubes placed into the tube-sheet assembly. In fact, this stream will normally be a two-phase flow at the tube outlet side; i.e., liquid and vapor. In the embodiment having two tube bundles (i.e., one carrying steam, the other carrying ammonium carbamate) each have at the entrance a liquid (viz., steam condensate, respectively ammonium-carbamate). In both bundles the liquid is heated, as a result of which a two-phase flow will occur. So, in both bundles a two-phase flow will leave the bundle. For the carbamate stream, this condition will enhance the erosion damage to the carbon steel if not protected by the sleeve.

To this end, the sleeves are attached to the corresponding holes by welding at or near either sheet surface. This has the interesting advantage that, attached this way, the sleeve will not be attached to the entire inner surface of the holes. This leaves an open space between said inner surface and the backside of the sleeve. This space can advantageously be used for providing a leak detection system as further discussed hereinbelow. A leak detection system presents the benefit that, in the event of a breach of the sleeve or sleeve weld, or by any other cause the inner surface of one or more holes displays corrosion and/or erosion, this can be timely dealt with.

The welding at or near the sheet surfaces requires adapting the carbon steel plate from which a tube-sheet would conventionally be made. This is needed in order to still meet the standards for use in a high-pressure environment. As the skilled person knows, the requirements laid down in the applicable codes for pressure vessels. Pressure vessels can be built according to several different National or International codes and standards. In the field of urea production, the following codes are normally used: ASME Boiler & Pressure Vessel Code (American) and the AD-2000 code (German). For the European market the pressure equipment must also comply with the PED directive of the European Union (Pressure Equipment Directive). These codes prevent manufacturers, inter alia, from direct welding operations on a carbon steel plate used for pressure-resistant equipment, such as in a high-pressure synthesis section of a urea production plant, without relieving the welding stresses after welding (so-called Post Weld Heat Treatment). To this end, the tube-sheet assembly preferably comprises a steel plate having a layered structure comprising a carbon steel inner layer, sandwiched on either side by at least two subsequent further layers. These include, at the side of the inner layer, one or more so-called buttering (or butter) layers; these layers all will have undergone a post weld heat treatment; the final layers, i.e., the outer layers are made of duplex stainless steel.

The butter layer can be made of a weld material which makes the transition of carbon-steel to a high alloyed final layer possible without diluting the final layer from its alloying elements needed for corrosion resistance. Typically, a so-called 309L buttering is used. 309L is an austenitic SS-steel typically consisting of, in addition to Fe, 24% Cr and 13% Ni and having a maximum carbon content of 0.03%.

The tube-sheet of the present invention is preferably intended to be suitable for use with a HP carbamate condensation apparatus, in particular for a urea plant. The apparatus may be a submerged condenser, for instance a pool condenser or a pool reactor. The tube-sheet of the present invention is particularly advantageous for application in a urea plant of the ULE type, preferably a Stamicarbon Ultra Low Energy (ULE) plant. Therein, as mentioned before, a set of tubes is provided to transport steam, whilst another set of tubes is provided to transport ammonium carbamate, notably MP carbamate. Each set of tubes has an inlet compartment and outlet compartment for feeding fluid and receiving fluid respectively. The first set of tubes is fed with a urea/carbamate/water containing stream which is heated whereby some of the carbamate decomposes in ammonia and CO₂ resulting in a two-phase (gas/liquid) stream. The second set of tubes is fed with water, typically process condensate which gets partly converted into steam resulting in a two-phase water/steam stream.

Incidentally, it is noted that the terms “high pressure” (HP), “medium pressure” (MP) and “low pressure” (LP) have a generally accepted meaning in the field of urea production. In a preferred embodiment, both sets of tubes are provided by presenting one set of tubes around the other. i.e., a set of concentric tube bundles. Thereby the inner of the concentric double tubes will be employed to carry steam. The outer of said concentric set of tubes, i.e., the tubes positioned at the HP side, will serve to carry MP carbamate.

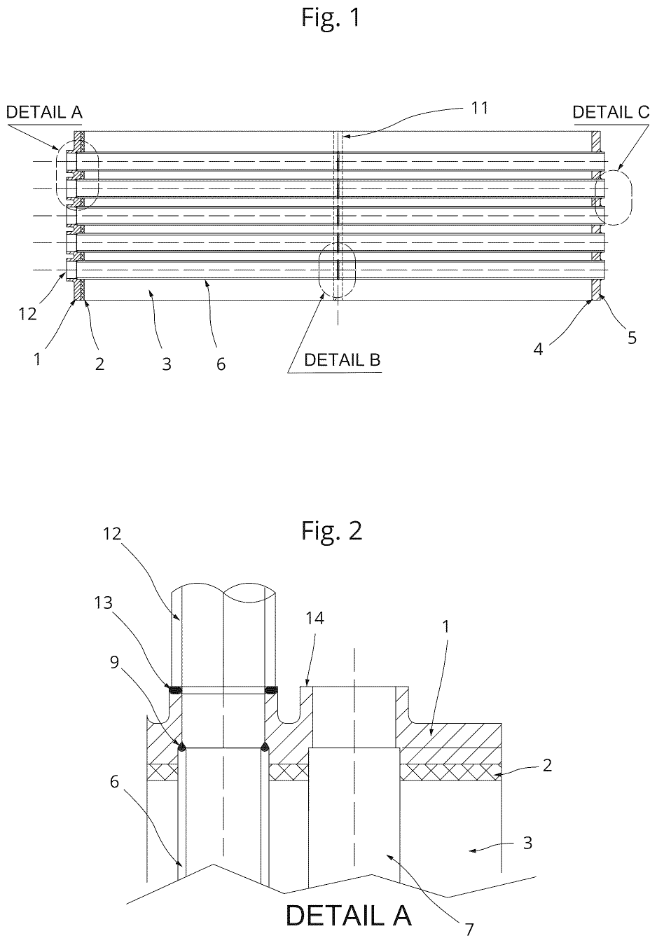

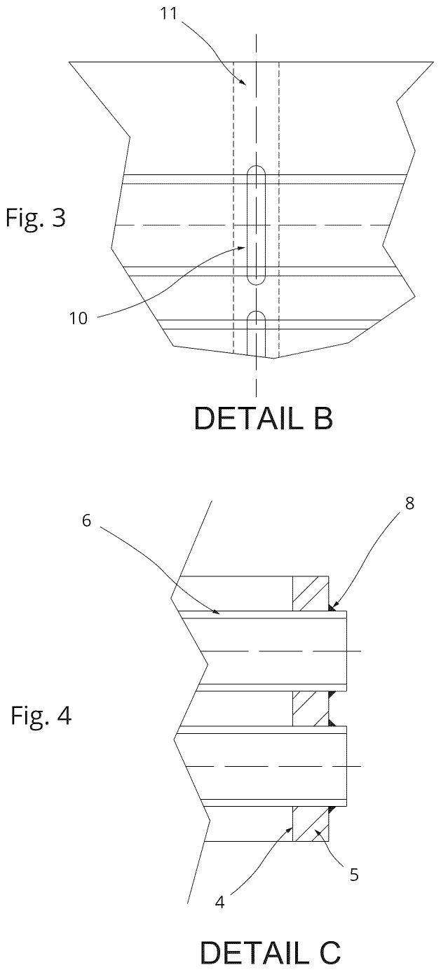

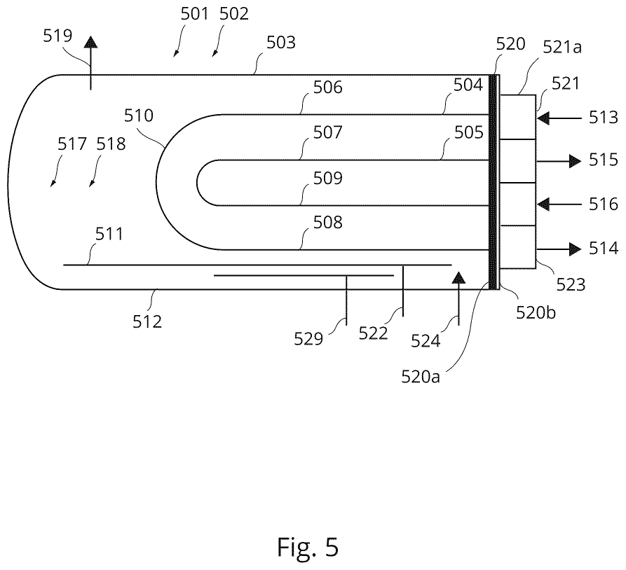

The tube-sheet assembly of the invention is further discussed hereinafter with reference to FIG. 1, and the details A, B, and C indicated therein and present in, respectively, FIG. 2, FIG. 3, and FIG. 4.

The tube-sheet assembly of the invention as depicted in FIG. 1 comprises at least the following plurality of consecutive layers placed one on top of the other.
a first layer (1), presenting the first sheet surface; this is made of duplex stainless steel; preferably, said first layer comprises a plurality of overlay welded corrosion protected layers, hereby indicated as sub-layers, each sub-layer applied by using overlay welding;
a second layer (2), applied by overlay welding, not presenting an outside sheet surface of the tube-sheet; this is a first butter layer (stainless steel, preferably 309L); it will be understood that butter layers can also be made of duplex or super duplex steel; however, from a cost point of view typically a 309L or 308L steel is preferred;
a third layer (3), typically the middle layer within a stack of layers forming the tube-sheet assembly; this is a steel layer (carbon steel, forged piece); this layer is, besides being chosen for weldability, essentially chosen in view of the need for the tube-sheet to be applicable in a high-pressure environment, and accounts for the required strength of the tube-sheet;
a fourth layer (4), which is a second butter layer (stainless steel, preferably 309L or 308L as discussed for the first butter later);
a fifth layer (5), which is a second corrosion resistant layer (preferably duplex stainless steel, more preferably a super duplex steel).

With reference to the possible use of the tube-sheet assembly in a urea production environment, the layer termed “first layer”, is intended to represent the HP shell-side of the tube-sheet assembly. Accordingly, for application in a condensation apparatus of a urea production plant, at least one outer surface (i.e., the first layer mentioned above) is made of a super duplex stainless steel, preferably Safurex. This side of the tube-sheet assembly of the invention will then face the high pressure environment of the condensation apparatus, i.e., the inside of the corresponding pressure vessel. The other side, facing away from the high pressure environment, i.e., facing to the outside of the vessel, is preferably also made of duplex stainless steel, but other austenitic stainless steel can be tolerated.

The sleeve (6) of the invention is connected to the tube-sheet by welding. At the aforementioned second sheet surface, this can be accomplished by a fillet weld (8), welded onto a weld overlay, generally fillet weld joint. At the aforementioned first surface, i.e., at the side where the tubes extend into a high-pressure vessel, this will be by means of an internal bore weld (IBW) (9).

Effectively, thereby inside the tube-sheet holes (7) a stainless steel sleeve is installed. This advantageously serves to protect the tube-sheet from corrosion at the positions in which this sheet would otherwise be prone to contact with medium pressure ammonium carbamate. The way the sleeve is connected, i.e., at one side by an internal bore weld (9) to a weld overlay and at the other side by a fillet (8) to a weld overlay, a confined space is created behind the sleeve closed at both sides with a weld.

This confined space advantageously lends itself to be formed in to a leak detection compartment. To this end, in a preferred embodiment, behind the sleeve a leak detection groove (10) is grinded into the hole wall to enhance the leak detection. In manufacturing a groove is machined inside each hole of the tube-sheet, before the sleeve is installed. The tube-sheet of the present invention displays a benefit by virtue of the fact that the sleeves are not applied by rolling, and are connected, at one or both sheet surfaces, to an overlay weld. On at least one end of the holes, this is an overlay weld inside the holes. As a result, the entire length of the sleeves (or, for that matter, equally the entire length of the holes), is available for positioning a leak detection groove. These grooves are typically machined into the carbon steel layer of the tube-sheet assembly. It is also possible to machine the grooves in the butter layer or in the outer layer.

In order to optimally serve to detect potential leaks from either end of the holes, the leak detection grooves are preferably applied at equal distance from either end. Each sleeve forms a leak detection compartment (LDC) and this compartment is connected with a passage way (11) in the form of a side drilled hole in the tube-sheet. The leak detection passages are operatively coupled to a leak detector, such as an ammonia detector. With such a leak detection system corrosive medium either from the shell side or from the tube side that accidentally enters the crevice between the sleeve and the core of the tube-sheet, thus coming in contact with the carbon steel, can be detected. Upon detection of presence of corrosive media in such a crevice, immediate corrective actions shall be taken to avoid severe damages of the carbon steel tube-sheet due to corrosion by the process medium. Preferably, all crevices between the sleeves and the respective bore holes in the tube-sheet are interconnected and connected via a tube to an ammonia detector. Upon leakage of the corrosive process medium (i.e. ammonium carbamate), said medium will enter the crevice and will decompose amongst other components into ammonia and is directly detected by the ammonia detector.

In order to manufacture the tube-sheet assembly of the invention, generally first a carbon steel sheet of desired dimension is provided. The manufacturing process further comprises overlay welding a butter layer on either side of the carbon steel sheet to provide an overlay welded sheet; subjecting the overlay welded sheet to post weld heat treatment (PWHT) to provide a PWHT treated sheet; overlay welding a plurality of corrosion resistant layers on either butter layer to form a corrosion resistant sheet; drilling bore holes throughout the tube-sheet assembly inserting sleeves of corrosion resistant steel in said bore holes; welding said sleeves onto the overlay welded corrosion resistant layers at either end of the bore holes. The so manufactured tube-sheet assembly of the invention is provided with U-shaped tubes. It will be understood that both ends of bundled U-tubes (12) are connected at the same side, i.e., at the side of the same sheet surface of the tube-sheet assembly. Typically, this will be at the weld overlay that forms the above-mentioned first layer, and this connection is accomplished by internal bore welding (13). To this end, a castellated hub (14) to connect the U-tube is preferably machined from said first layer.

The condensation apparatus of the invention is discussed with reference to FIG. 5. The HP carbamate condensation apparatus (501) depicted therein comprises a shell-and-tube heat exchanger (502) which comprises a shell (503) and a first and a second horizontal U-shaped tube bundle (504, 505). The heat exchanger hence has a tube side and a shell side.

With respect to the HP carbamate condensation apparatus (501), the horizontal direction is defined by the legs of the tubes (504, 505), the legs are horizontally arranged. Additionally, the length direction is defined by the legs of the tubes (504, 505), which are arranged in the length direction. The bottom section of the HP carbamate condensation apparatus (501) is defined by the first fluid distributor (511). For the urea plant, vertical is defined with respect to gravity and the HP carbamate condensation apparatus (501) is arranged accordingly.

The shell (503) confines the shell side space (518). The shell is for instance a vessel having a horizontal length direction; preferably a cylindrical vessel. The shell is for instance at one end capped with a cap, e.g. a substantially hemispherical cap part, and at another end closed by a tube-sheet, or is for instance at two ends capped with a cap. The cap and tube-sheet, or the two caps, delimit the shell side space (518) and are at the internal side exposed to HP process medium in the shell side space (518).

Preferably, the condensation apparatus (501) comprises a tube sheet (520), wherein the tube bundles (504, 505) are arranged at a first side (520a) of said tube sheet (520) and said inlet (513) and outlet (514) for MP urea-comprising stream are provided by headers (521) arranged at a second side (520b) of said tube sheet (520). The first side (520a) is facing the shell side space (518) and is hence exposed to the shell side space (518). The second side (520b) of the tube sheet (520) is external and is not exposed to the shell side space (518). The tube sheet (520) seals off the shell (503) and the shell side space (518).

Generally, the first U-shaped tube bundle (504) has an inlet end and an outlet and. Typically all tube ends of the inlet end are directly connected to a single inlet connection chamber (521a) which in turn is connected to the inlet (513) for the MP urea stream. Typically all tube ends of the outlet end are directly connected to a single outlet connection chamber which in turn is connected to the outlet (514) for the MP urea stream.

The tube bundles each have an upper leg portion (506,507) and a lower leg portion (508,509) connected by a bend portion (510). Each tube of the tube bundle comprises two horizontal legs connected by a bend. The legs of the tubes are arranged in parallel in a tube bundle in the length direction of the shell (503). The upper and lower leg of a tube are vertically spaced apart and are connected by the bent part of the U-shaped tube.

The total number of tubes in the tube bundles is e.g. at least 50 or at least 100 or at least 500. The first and second tube (504, 505) bundle for instance comprise at least 100 tubes each. The number of tubes depends on plant capacity.

In the invention, the first U-shaped tube bundle (504) is arranged, e.g. looped, around the second U-shaped tube bundle (505), i.e. the first U-shaped tube bundle (504) is arranged concentrically around the second U-shaped tube bundle (505). The bends of the first tube bundle are hence preferably concentric with the bends of the second U-shaped tube bundle (505). The first U-shaped tube bundle (504) is the outer tube bundle and is arranged the closest to the shell. The second U-shaped tube bundle (505) is typically at least partially enveloped by the outer first U-shaped tube bundle.

The upper leg portion (506) of the outer first U-shaped tube bundle (504) is proximally connected to the inlet (513) for the MP urea-comprising stream. The lower leg portion (508) of the outer first U-shaped tube bundle (504) is proximally connected to the outlet (514) for the MP urea-comprising stream.

Herein, proximally connected indicates in particular a connection for fluid flow between the leg portion and the inlet respectively outlet without passing through the bend portion (510) of the tubes.

In particular, the condensation apparatus comprises a connection chamber (521a) that is directly connected to the upper leg portion (506) of the outer first U-shaped tube bundle (504) and connected, optionally through a duct, to the inlet (513) for the MP urea-comprising stream. The connection chamber (521a) is for example a header (521) as shown in present FIG. 1 used in combination with a tube sheet (520). Such a header is also shown in FIG. 1 of US 2020/0306663A1. The connection chamber can also be provided by a redistribution chamber and duct, for example as shown in FIG. 2A of US 2020/0306663A1.

Preferably the lower leg portion (508) of the outer first U-shaped tube bundle (504) is directly connected to a connection chamber (521a) that is connected, optionally through a duct, to the outlet (514) for the MP urea-comprising stream

Preferably the upper leg portion (507) of the inner second U-shaped tube bundle (505) is proximally connected to an outlet for steam (515) and the lower leg portion (509) of the inner second U-shaped tube bundle (505) is proximally connected to an inlet for boiler feed water (516); again preferably through a connection chamber (521a).

The inner second U-shaped tube bundle (505) is configured for raising steam, in particular is connected to an inlet for boiler feed water (516) and an outlet (515) for steam. The outlet (515) is for instance connected to a steam drum. The inlet for boiler feed water (516) is for instance connected to a steam condensate tank which comprises e.g. a condensation unit. The boiler feed water is for instance steam condensate. The boiler feed water at the inlet (516) is for instance at 4-5 bar gauge. The fluid at the outlet (515) comprises steam and optionally condensate (wet steam). The fluid at the outlet (515) is e.g. 3.5-4.5 bar gauge steam.

Preferably the outlet (514) for the MP urea-comprising stream has a larger flow area, than the inlet (513) for the MP urea-comprising stream, preferably at least 1.1 or at least 1.2 times larger. Thereby the condensation apparatus is adapted for carbamate dissociation in the first U-shaped tube bundle giving two-phase fluid flow at the outlet (514).

Optionally the outlet (514) for the MP urea-comprising stream is provided by two or more outlet nozzles and the total flow area of these outlet nozzles is larger than that of the inlet. The flow area of the individual nozzles may be smaller than that of the inlet.

Optionally the inlet (513) for the MP urea-comprising stream is provided by two or more inlet nozzles.

Preferably the condensation apparatus, more preferably the vessel, comprises a reaction zone (517) in the shell (503), i.e. in the shell side space (518), between the bend (510) of the first U-shaped tube bundle (504) and the shell (503). The reaction zone extends (517) over e.g. at least 10% or at least 20% and/or up to 60% of the length of the vessel and shell (503). The reaction zone (517) has a size in the length direction of the shell (503) of e.g. at least 20% or at least 50% or e.g. at least 60% and or up to 150% of the length of the straight parts (individual leg) of the outer first U-shaped tube bundle.

Preferably the condensation apparatus, more preferably the vessel, comprises a second fluid distributor, in particular a sparger, arranged at a bottom section of the condensation apparatus for distributing a second high pressure gas stream, in particular NH₃, more in particular NH₃ feed, at the shell side (503), in particular into the shell side space (518). Preferably the second fluid distributor extends horizontally, below the first tube bundle (504), and preferably is coterminous with the bend (510) of the first tube bundle (504). If a reaction zone (517) is present, the second fluid distributor, in particular the NH₃ sparger, preferably does not extend into the reaction zone. The NH₃ sparger is connected to an inlet for NH₃ in the shell. The optional NH₃ sparger (529) is illustrated in FIG. 5.

The parts of the carbamate condensation apparatus (501) that are in contact with the process medium, especially at higher temperature (for example the process medium condensing at high pressure in the condenser) are typically made of corrosion resistant materials, in particular urea grade steel, such as an austenitic-ferritic duplex stainless steel (duplex steel). For instance, the shell is at the inside provided with overlay welding (i.e. a weld overlay) or internal lining made of urea grade steel or other corrosion resistant metal, e.g. duplex austenitic-ferritic stainless steel, preferably Safurex type steel, AISI 316L steel, or INOX 25/22/2 Cr/Ni/Mo steel.

Such internal lining is typical for the shell of a HP carbamate condensation apparatus (501). The outside shell is e.g. a carbon steel shell and is e.g. at least 30 mm or at least 40 mm thick.

The HP carbamate condensation apparatus (501) preferably further comprises a first fluid distributor (511). The first fluid distributor (511) is arranged in the shell (503) at a bottom section (512) of the condensation apparatus (501). The first fluid distributor (511) is used for distributing a first high pressure gas stream, in particular from the HP stripper, at the shell side, i.e. in the shell side space (518). The first HP gas stream may be supercritical. The first fluid distributor is in particular arranged horizontally, for horizontally distributing the gas stream.

The first fluid distributor (511) is for instance a sparger. A sparger for instance comprises a tube extending in the length of the shell, wherein said tube is provided with arms extending in the width direction at both sides of the tube. The arms are spaced apart in the length direction. The arms have numerous outlet openings for gas (e.g. more than 50 openings per arm) at the upper side of the arms. A sparger may comprise two or more of such tubes with arms. Generally, the first fluid distributor is provided with an upper surface containing a large number (e.g. more than 50) outlet openings for gas which are distributed in the length and width direction.

The first fluid distributor (511) is connected to a gas inlet (522) comprised in the shell (503); the gas inlet is configured to supply gas to be condensed into shell side space (518).

The first fluid distributor (511) and the straight parts (legs) of the tubes of the tube bundles extend in parallel in the length direction of the shell (503). The arms extend horizontally over the width direction, i.e. perpendicular to the length direction.

The first fluid distributor (511) is typically configured for distributing a fluid over the width of the tube bundles (504, 505) and at least over the length of the tube bundles (504, 505); preferably the tube bundles (504, 505) have the same width and the leg parts of the first and second U-shaped tube bundle (504, 505) have the same length. The shell (503) is wider than the tube bundles (504, 505) and permits for downward fluid flow in the shell side space around the tube bundles (504, 505).

The shell side (518) of the HP carbamate condensation apparatus (501) furthermore typically comprises a carbamate inlet (524) for receiving recycle carbamate solution from one or more recovery sections that are used to purify urea solution from the HP synthesis section.

The shell (503) furthermore comprises an outlet (519) for process fluid for withdrawing process fluid from the shell side space (518). The process fluid comprises a solution comprising urea and carbamate.

In some embodiments, the shell side space (518) is completely filled with process fluid in operation and the process fluid at the outlet (519) includes both gas and liquid. The process fluid is e.g. supplied to a gas/liquid separation unit external of the condensation apparatus. The outlet (519) is arranged at a top side of the shell (503) in such embodiments.

In some embodiments, a liquid level is maintained in the shell side space (518) in operation and the condensation apparatus comprises a liquid overflow element in the shell side space (518), such as a baffle or a downcomer. The overflow element may act as a weir, preferably in conjunction with a gas outlet at the top.

In operation, the entire first and the second tube bundle (504, 505) are submerged by and in the liquid phase in the shell side space (518). Hence, the HP carbamate condensation apparatus (501) provides a horizontal submerged carbamate condenser.

The HP carbamate condensation apparatus (501) comprises an inlet (513) and an outlet (514) for MP urea-comprising stream, i.e. for a fluid stream comprising a liquid phase comprising urea. The liquid phase also comprises carbamate at least at the inlet (513) and typically also, but less, at the outlet (514). The fluid stream also comprises gas, at least at the outlet (514) due to decomposition of at least part of the carbamate during the passage of the fluid through the first U-shaped tube bundle (504). The fluid is at a pressure in the medium pressure (MP) range at the inlet and the outlet.

The MP urea-comprising stream inlet (513) and outlet (514) are both connected to the first U-shaped tube bundle (504).

The MP urea-comprising stream inlet (513) and outlet (514) are provided in an external wall (523) of the HP carbamate condensation apparatus (501). The external wall (523) is typically insulated on the outside, rather than directly exposed to the outside environment in a urea plant. The external wall (523) may be provided, for example, by the shell (503) or by an additional element of the apparatus, such as a header (521) located outside of the shell (503).

The inlet (513) and the outlet (514) are both provided with connecting means, such as flanges, for coupling to a fluid flow line of the plant for the MP urea stream, e.g. to piping.

The inlet (513) and outlet (514) are both connected to the first U-shaped tube bundle (504) through a respective connection chamber which connects the inlet respectively outlet to the large number of tubes of the tube bundle. The connection chamber is e.g. a header (521) formed in part by the tube-sheet (520).

In sum, a tube-sheet is disclosed which is suitable for holding a tube bundle of a shell-and tube heat exchanger adapted to withstand the pressure at the shell side. Said sheet comprises a carbon steel plate provided with a plurality of holes. Both surfaces of the tube-sheet are covered by a weld overlay, said weld overlay comprising a layer of duplex stainless steel on at least one surface thereof. The sleeves are fixed to the tube-sheet by means of a weld connection to either weld overlay. Hereby at least one such connection is on the inside of the holes.

1. A tube-sheet assembly suitable for holding a tube bundle of a shell-and tube heat exchanger, said tube-sheet assembly comprising a carbon steel sheet having first and second sheet surfaces facing away from each other, said carbon steel sheet being covered on either sheet surface by a weld overlay comprising an outer layer made of duplex stainless steel, said tube-sheet assembly being provided with a plurality of holes defined by hole walls extending from one outer surface to the other, wherein said holes are provided on the inside with a sleeve made of duplex stainless steel, the sleeves protecting the carbon steel part of the hole walls in their entirety, wherein the sleeves are fixed to the tube-sheet assembly by means of a weld connection to either weld overlay, and wherein on at least one end of the sleeves said weld connection is on the inside of the hole.

2. A tube-sheet assembly according to claim 1, wherein the weld overlays on either side of the carbon steel sheet comprise stainless steel buttering layers, said buttering layers each covered with layers made of duplex stainless steel.

3. A tube-sheet according to claim 1, wherein the weld connections of the sleeves to the weld overlays comprise fillet welds on the end facing away from the weld connection on the inside of the holes.

4. A tube-sheet according to claim 1, wherein the duplex stainless steel has an elementary composition consisting of, in percentages by weight:

| | |
|---|---|
| C | 0-0.05; |
| Si | 0-0.8; |
| Mn | 0-4.0; |
| Cr | 26-35; |
| Ni | 3.0-10; |
| Mo | 0-4.0; |
| N | 0.30-0.55; |
| Cu | 0-1.0; |
| W | 0-3.0; |
| S | 0-0.03; |
| Ce | 0-0.2; |

the balance being Fe and unavoidable impurities.

5. A tube-sheet according to claim 1, wherein the duplex stainless steel has an elementary composition consisting of, in percentages by weight:

| C | max | 0.030; |
|---|---|---|
| Si | max | 0.8; |
| Mn | max | 2.0; |
| Cr | 29.0 | to 31.0; |
| Ni | 5.0 | to 9.0; |
| Mo | less than 4.0; | |
| W | less than 4.0; | |
| N | 0.25-0.45; | |
| Cu | max | 2.0; |
| S | max | 0.02; |
| P | max | 0.03; |

with the balance being Fe and unavoidable occurring impurities; and wherein the content of Mo+W is greater than 3.0 but less than 4.0.

6. A tube bundle heat-exchanger comprising at least one U-shaped tube bundle, said tubes comprising first and second leg portions connected by a bend portion, either leg having first and seconds tube ends facing away from the bend portion, said tube ends being configured for fluid connection allowing fluid to enter the tubes at a first tube end and exit the tubes at a second tube end, wherein said first and second tube ends are connected with a tube-sheet assembly according to claim 1, wherein at the side of tube-sheet assembly having the connection with the tube ends, the weld connection of the sleeves is on the inside of the holes.

7. A condensation apparatus comprising a pressure vessel, said pressure-vessel provided with a shell-and tube heat exchanger as described in claim 6, wherein, at the surface of the tube-sheet facing away from the tube bundle, the holes in the tube-sheet are in fluid communication with one or more outlets of the pressure vessel.

8. A condensation apparatus according to claim 7, wherein the tubes are comprised in two separate tube bundles.

9. A condensation apparatus according to claim 8, wherein the tube bundles are concentric, having an outer tube bundle positioned around an inner tube bundle.

10. A urea production unit comprising a high-pressure synthesis section comprising a HP stripper, a reaction zone, and a high pressure carbamate condensation apparatus, wherein the condensation apparatus
comprises a pressure vessel, said pressure-vessel provided with a shell-and tube heat exchanger, wherein, at the surface of the tube-sheet facing away from the tube bundle, the holes in the tube-sheet are in fluid communication with one or more outlets of the pressure vessel;
wherein the shell-and-tube heat exchanger comprises at least one U-shaped tube bundle, said tubes comprising first and second leg portions connected by a bend portion, either leg having first and seconds tube ends facing away from the bend portion, said tube ends being configured for fluid connection allowing fluid to enter the tubes at a first tube end and exit the tubes at a second tube end, wherein said first and second tube ends are connected with a tube-sheet assembly according to claim 1, wherein at the side of tube-sheet assembly having the connection with the tube ends, the weld connection of the sleeves is on the inside of the holes;
and wherein the high pressure synthesis section has a liquid flow connection for urea solution through an expansion device configured to be operated at medium pressure, to an inlet of the at least one U-shaped tube bundle of said condensation apparatus.

11. A urea production unit according to claim 10,
wherein the tubes are comprised in two separate tube bundles
wherein the tube bundles are concentric, having an outer tube bundle positioned around an inner tube bundle
and wherein the liquid flow connection for urea solution is to an inlet of the outer concentric tube bundle.

12. A method of modifying a pre-existing urea production unit, said unit comprising a tube bundle heat exchanger comprising at least one U-shaped tube bundle, said tubes comprising first and second leg portions connected by a bend portion, either leg having first and seconds tube ends facing away from the bend portion, said tube ends being configured for fluid connection allowing fluid to enter the tubes at a first tube end and exit the tubes at a second tube end, wherein said first and second tube ends are connected with a tube-sheet, said tube-sheet comprising a carbon steel sheet having first and second sheet surfaces facing away from each other, said carbon steel sheet being provided with a plurality of holes defined by hole walls extending from one sheet surface to the other, said holes having a fluid connection with the tube ends connected thereto, wherein the method comprises replacing the tube bundle heat exchanger by a tube bundle heat exchanger comprising at least one U-shaped tube bundle, said tubes comprising first and second leg portions connected by a bend portion, either leg having first and seconds tube ends facing away from the bend portion, said tube ends being configured for fluid connection allowing fluid to enter the tubes at a first tube end and exit the tubes at a second tube end, wherein said first and second tube ends are connected with a tube-sheet assembly according to claim 1, wherein at the side of tube-sheet assembly having the connection with the tube ends, the weld connection of the sleeves is on the inside of the holes.

13. A shell-and tube heat exchanger comprising a tube bundle and the tube-sheet assembly of claim 1, wherein the tube-sheet assembly holds the tube bundle.
